(19) United States
(12) Patent Application Publication
(10) Pub. No.: US 2006/0102620 A1
(43) Pub. Date: May 18, 2006

(54) Heat treat process

(75) Inventor: Vladimir Frankfurt, Northbrook, IL (US)

Correspondence Address: BRINKS HOFER GILSON & LIONE, P.O. BOX 10395, CHICAGO, IL, 60610, US

(73) Assignee: NTN Corporation

(21) Appl. No.: 10/987,691

(22) Filed: Nov. 12, 2004

(51) Int. Cl. H05B 6/06

(52) U.S. Cl. 219/663

(57) ABSTRACT

A system for monitoring an induction hardening process is provided. The system includes an induction coil, a control circuit, and a monitoring circuit and a quenching system. The induction coil is configured to heat a workpiece. The control circuit is connected to the induction coil and configured to provide electrical energy to the induction coil. The quenching system is configured to quench the workpiece after it has been heated by the induction coil. The monitoring circuit is in communication with the induction coil and the quenching circuit to monitor heating and quenching parameters and determine a workpiece status based on the heating and quenching parameters.

### BACKGROUND

The present invention generally relates to an industrial process monitoring circuit. More specifically, the invention relates to a system for monitoring an induction hardening process.

Induction heating equipment is used for heat treating metal parts, such as, rolling element bearing components. Heat treatment is used to produce desired phase characteristics and hardness of the parts and can relieve internal stresses. In induction heat treatment, an induction coil induces heat in the part through a magnetic field which induces eddy currents in the part and their dissipation produces resistive heating. Typically, each part is heated individually rather than in batches, as would be done by a furnace. Since the induction coil and heated parts are integrally linked through the magnetic field, any changes in the part which occur during heating, is reflected in the coil signature. Accordingly, coil signature information yields substantial information about the heat treatment process. After the part is heated, the workpiece is quenched or quickly cooled. Quenching may be accomplished by immersing the workpiece in a liquid bath. The heating and quenching of the part together determine the resulting hardness properties of the part.

Many manufacturers simply assume that the power source controls are able to supply the same energy and power every cycle of induction heating. Often, the actual energy delivered to the part and ultimately the part quality can be easily affected by contact resistance changes, inductance losses, coil part position, variations in electromagnetic properties, and many other factors. In addition, the temperature change and time in which the part is quenched significantly influences the induction heating process and the part quality.

In view of the above, it is apparent that there exists a need for an improved system for monitoring an induction hardening process.

### SUMMARY OF THE INVENTION

In satisfying the above need, as well as, overcoming the enumerated drawbacks and other limitations of the related art, the present invention provides a system for monitoring an induction hardening process.

The system includes an induction coil, a control circuit, and a monitoring circuit and a quenching system. The induction coil is configured to heat a workpiece. The control circuit is connected to the induction coil and configured to provide electrical energy to the induction coil. The quenching system is configured to quench the workpiece after it has been heated by the induction coil. The monitoring circuit is in communication with the induction coil and the quenching circuit to monitor heating and quenching parameters and determine a workpiece status based on the heating and quenching parameters. The workpiece status corresponds to quality of the hardening process and therefore, corresponds to the hardness properties of the workpiece.

In another aspect of the present invention, the monitoring circuit is configured to determine a workpiece status by comparing the measured heating and quenching parameters to workpiece evaluation criteria. The heating and quenching parameters may include but are not limited to, the quench temperature, energy provided to the induction coil, power provided to the induction coil, current profile, voltage profile, heat time, flow start, flow finish, quench flow, and quench pressure. Further, the workpiece evaluation criteria may include but are not limited to, an upper and lower limit for the quench temperature, power, energy, current profile, voltage profile, heat time, flow start, flow finish, and quench pressure.

In another aspect of the present invention, the monitoring circuit is configured to store a plurality of workpiece evaluation criterion. The system is further configured to receive a workpiece identifier and evaluate a workpiece status according to one of the plurality of workpiece evaluation criteria based on the workpiece identifier.

In yet another aspect of the present invention, the controller circuit is configured to adjust process parameters based on the monitored heating and quenching parameters.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a diagrammatic view of an induction hardening system in accordance with the present invention; and

FIG. 2 is a flow chart of a process for controlling and monitoring an induction heating system in accordance with the present invention.

### DETAILED DESCRIPTION OF THE INVENTION

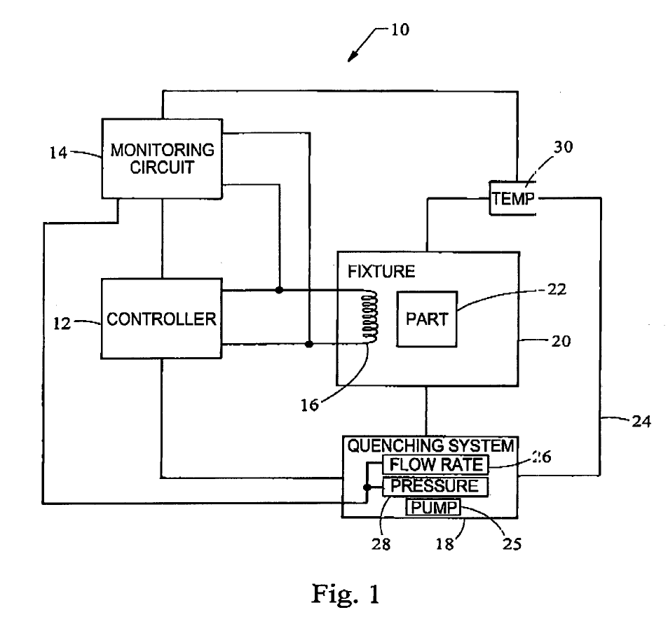

Referring now to FIG. 1, a system embodying the principles of the present invention is illustrated therein and designated at 10. As its primary components, the system 10 includes a controller circuit 12, a monitoring circuit 14, an induction coil 16, and a quenching system 18.

To provide electrical energy during the induction heating process the controller 12 is electrically connected to the induction coil 16. The part 22 is heated by the induction coil 16 through a magnetic field. The controller 12 manipulates the amount of energy, the amount of power, the voltage profile, the current profile, and heating time to control the induction heating process. The monitoring circuit 14 is connected to the induction coil 16 to monitor a voltage and current profile with respect to time during the induction process. In addition, the monitoring circuit 14 monitors the power, energy, and heat time of the induction heating process, these parameters may generally be derived from the voltage and current profiles. The controller circuit 12 is in communication with the quenching system 18 to control quenching parameters such as flow start, flow finish, quench temperature, quench flow, and quench pressure. In addition, the monitoring circuit 14 is in communication with both the quenching system 18 and controller 12. The monitoring circuit 14 is connected to the quenching system 18 to monitor quenching process parameters. The monitoring circuit 14 is also in communication with the controller 12, allowing the controller 12 to provide feedback signals to adjust the heating and quenching process or alert the operator, if monitored process parameters exceed evaluation criteria.

After the part 22 has been heated, the quenching system 18 pumps fluid into the fixture 20 immersing the part 22. The fluid is recycled into the quenching system 18 through a fluid return 24. The quenching system 18 includes a pump 25, a flow rate sensor 26, a pressure sensor 28, and a temperature sensor 30. The pump 25 provides-fluid for quenching the part 22. The flow rate sensor 26 measures the flow rate of the fluid entering the fixture 20. The pressure sensor 28 measures the pressure of the stream fluid as the fluid enters the fixture 20. The temperature sensor 30 measures the temperature of the fluid in the fluid return 24 after quenching the part 22. The monitoring circuit 14 is in communication with the flow rate sensor 26, pressure sensor 28, and temperature sensor 30 to monitor the quench parameters during the quench process of the heat treatment.

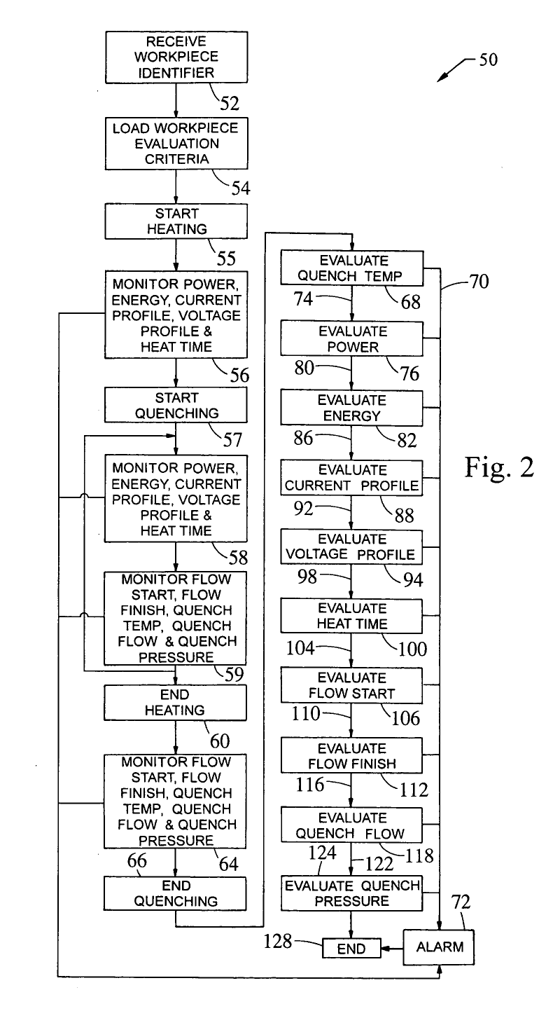

Now referring to FIG. 2, a process 50 for controlling and monitoring an induction heating system is provided. The process 50 begins as the controller 12 receives a workpiece identifier as denoted by block 52. In block 54, the controller 12 loads workpiece evaluation criteria based on the workpiece identifier. The controller 12 initiates heating by providing power to the induction coil 16 as denoted by block 55. The monitoring circuit 14 monitors heating parameters, such as, power, energy, current profile, voltage profile, and heat time during heating as denoted by block 56. If a monitored parameter varies outside of an acceptable range as defined by the workpiece evaluation criteria an alarm will be activated as denoted in block 72. After the part 22 has been heated, the controller 12 provides a signal to the quenching system 18 to begin quenching as denoted by block 57.

The part 22 may be quenched and heated multiple times during the process and may even be heated and quenched simultaneously at some times. During heating periods, heating parameters will continue to be monitored as denoted by block 58. Similarly, during quenching periods, quenching parameters, such as, flow start, flow finish, quench temperature, quench flow, and quench pressure, are continuously monitored as denoted by block 59. Again, if a monitored parameter varies outside of an acceptable range as defined by the workpiece evaluation criteria an alarm will be activated as denoted in block 72

The flow start is the time at which the fluid is provided to the part 22 for cooling. Generally, the flow start is quickly after heating is finished to provide a quick transition from heating to cooling of the part, thereby producing a hardening of the part 22. Flow finish is the time at which the quenching fluid stops being introduced to the part 22. The quench temperature is the temperature of the quenching fluid after the part 22 has been quenched. The quench flow is the rate of fluid provided to the part 22 at any point in time. Commonly, the flow rate is measured in gallons per minute. The quench pressure is the pressure of the stream of quenching fluid as it is introduced to the part 22. After heating is completed as denoted by block 60, the system may continue quenching the part 22 until cooled. Accordingly, the quenching parameter continues to be monitored as denoted by block 64. Once again, if a monitored parameter varies outside of an acceptable range as defined by the workpiece evaluation criteria an alarm will be activated as denoted in block 72. In block 66, the controller 12 sends a signal to the quenching system 18 to cease quenching of the part 22.

In block 68, the monitoring circuit 14 evaluates the quench temperature of the quenching fluid. If the quench temperature is outside the quench temperature evaluation criteria, such as above the upper or below the lower temperature limit, the logic flows along path 70 to block 72 where an alarm status is noted and the process ends in block 128. If the quench temperature falls within the quench temperature evaluation criteria, the logic flows along line 74 to block 76.

In block 76, the monitoring circuit 14 evaluates the power provided to the heating coil. If the power is outside the heating power evaluation criteria, such as above the upper or below the lower power limits, the logic flows along path 70 to block 72 where an alarm status is noted and the process ends in block 128. If the power falls within the heating power evaluation criteria, the logic flows along line 80 to block 82.

In block 82, the monitoring circuit 14 evaluates the heating energy of the induction coil. If the heating energy is within the heating energy evaluation criteria, such as between an upper and lower energy limit, the logic flows along line 86 to block 88. If the heating energy falls outside the heating energy evaluation criteria, the logic flows along path 70 to block 72 where an alarm status is noted and the process ends in block 128

In block 88, the monitoring circuit 14 evaluates the current profile of the current provided to the induction coil. If the current profile is within the current profile evaluation criteria, such as between an upper and lower current profile limit, the logic flows along line 92 to block 94. If the current profile falls outside the current profile evaluation criteria, the logic flows along path 70 to block 72 where an alarm status is noted and the process ends in block 128.

In block 94, the monitoring circuit 14 evaluates the voltage profile of the voltage across the induction coil. If the voltage profile is within the voltage profile evaluation criteria, such as between an upper and lower voltage profile limit, the logic flows along line 98 to block 100. If the voltage profile falls outside the voltage profile evaluation criteria, the logic flows along path 70 to block 72 where an alarm status is noted and the process ends in block 128.

In block 100, the monitoring circuit 14 evaluates the heat time of the induction coil. If the heat time is within the heat time evaluation criteria, such as between an upper and lower heat time limit, the logic flows along line 104 to block 106. If the heat time falls outside the heat time evaluation criteria, the logic flows along path 70 to block 72 where an alarm status is noted and the process ends in block 128.

In block 106, the monitoring circuit 14 evaluates the quench flow start time of the quenching fluid. If the quench flow start time is within the quench flow start time evaluation criteria, such as between an upper and lower flow start time limit, the logic flows along line 110 to block 112. If the quench flow start time falls outside the quench flow start time evaluation criteria, the logic flows along path 70 to block 72 where an alarm status is noted and the process ends in block 128.

In block 112, the monitoring circuit 14 evaluates the quench flow finish time of the quenching fluid. If the quench flow finish time is within the quench flow finish time evaluation criteria, such as between an upper and lower flow finish time limit, the logic flows along line 116 to block 118. If the quench flow finish time falls outside the quench flow finish time evaluation criteria, the logic flows along path 70 to block 72 where an alarm status is noted and the process ends in block 128.

In block 118, the monitoring circuit 14 evaluates the quench flow rate of the quenching fluid. If the quench flow rate is within the quench flow rate evaluation criteria, such as between an upper and lower flow rate limit, the logic flows along line 122 to block 124. If the quench flow rate falls outside the quench flow rate evaluation criteria, the logic flows along path 70 to block 72 where an alarm status is noted and the process ends in block 128.

In block 124, the monitoring circuit 14 evaluates the quench pressure of the quenching fluid. If the quench pressure is within the quench pressure evaluation criteria, such as between an upper and lower pressure limit, the logic flows to block 128 where the process ends. If the quench pressure falls outside the quench pressure evaluation criteria, the logic flows along path 70 to block 72 where an alarm status is noted and the process ends in block 128.

The process 50 shows the process alarming and ending after one of the evaluation steps fail. However, it is also contemplated that each evaluation be configured to set an individual alarm and allow the process flows to the next evaluation step.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A system for monitoring an induction heating process, the system comprising:
an induction coil configured to heat a workpiece;
a control circuit configured to provide electrical energy to the induction coil;
a quenching system configured to quench the workpiece while the workpiece is being heated; and
a monitoring circuit configured to concurrently monitor heating and quenching parameters and determine a workpiece status based on the heating and quenching parameters, wherein the monitoring circuit is in communication with a flow rate sensor configured to measure a quench flow rate and the quenching parameters includes the quench flow rate.

2. The system according to claim 1, wherein the monitoring circuit is configured to determine a workpiece status by comparing the heating and quenching parameters to workpiece evaluation criteria.

3. The system according to claim 1, wherein the controller circuit is configured to adjust process parameters based on the monitored heating and quenching parameters.

4. The system according to claim 1, wherein the quenching parameters include quench temperature.

5. The system according to claim 4, wherein the workpiece status is determined by comparing the quench temperature to an upper quench temperature limit and lower quench temperature limit.

6. The system according to claim 1, wherein the heating parameters include power provided to the induction coil.

7. The system according to claim 6, wherein the workpiece status is determined by comparing the power to a upper power limit and lower power limit.

8. The system according to claim 1, wherein the heating parameters include energy provided to the induction coil.

9. The system according to claim 8, wherein the workpiece status is determined by comparing the energy to an upper energy limit and lower energy limit.

10. The system according to claim 1, wherein the heating parameters include current profile.

11. The system according to claim 10, wherein the workpiece status is determined by comparing the current profile to an upper current profile limit and lower current profile limit.

12. The system according to claim 1, wherein the heating parameters include voltage profile.

13. The system according to claim 12, wherein the workpiece status is determined by comparing the voltage profile to an upper voltage profile limit and lower voltage profile limit.

14. The system according to claim 1, wherein the heating parameters include heat time.

15. The system according to claim 14, wherein the workpiece status is determined by comparing the heat time to an upper heat time limit and lower heat time limit.

16. The system according to claim 1, wherein the quenching parameters include flow start time.

17. The system according to claim 16, wherein the workplece status is determined by comparing the flow start time to an upper flow start limit and lower flow start limit.

18. The system according to claim 1, wherein the quenching parameters include flow finish time.

19. The system according to claim 18, wherein the workpiece status is determined by comparing the flow finish time to an upper flow finish time limit and lower flow finish time limit.

20. (canceled)

21. The system according to claim 1, wherein the workpiece status is determined by comparing the quench flow rate to an upper quench flow rate limit and lower quench flow rate limit.

22. The system according to claim 1, wherein the quenching parameters include quench pressure.

23. The system according to claim 22, wherein the workpiece status is determined by comparing the quench pressure to an upper quench pressure limit and lower quench pressure limit.

24. The system according to claim 1, wherein the monitoring circuit is configured to store a plurality of workpiece evaluat on criteria.

25. The system according to claim 24, wherein the monitoring circuit is configured to receive a workpiece identifier.

26. The system according to claim 25, wherein the monitoring circuit is configured to evaluate workpiece status according to one of the plurality of workpiece evaluation criteria based on the workpiece identifier.

27. The system according to claim 25, wherein the monitoring circuit is in communication with a flow rate sensor configured to measure a quench flow rate and the quenching parameters includes the quench flow rate.
